(19) United States
(12) Patent Application Publication
(10) Pub. No.: US 2020/0074399 A1
(43) Pub. Date: Mar. 5, 2020

(54) SECURE DELIVERY SYSTEM AND METHOD

(71) Applicant: Mastercard International Incorporated, Purchase, NY (US)

(72) Inventors: Christopher T. Scholl, Saint Peter's, MO (US); Madeline F. Mueller, St. Paul, MO (US); Shawn J. Mehrhoff, Saint Ann, MO (US)

(73) Assignee: Mastercard International Incorporated, Purchase, NY (US)

(21) Appl. No.: 16/116,707

(22) Filed: Aug. 29, 2018

(51) Int. Cl. G06Q 10/08; G06K 7/14; G06K 19/06

(52) U.S. Cl. CPC G06Q 10/0836; G06K 19/06037; G06K 7/1417

(57) ABSTRACT

A secure delivery system for securely delivering an article between a sender and a recipient. The secure delivery system includes a repository comprising a housing presenting an interior space and configured to securely hold articles. The system additionally includes a hatch integrated with the repository and configured to provide selective access to the interior space of the repository. A user interface is associated with the hatch and is configured to receive instructions to permit opening of the hatch to provide access to the interior space of the repository. The system additionally includes a communications element configured to a transmit a delivery notification to the recipient. The system further includes an autonomous courier device configured to transport the articles from a geographic location remote from the repository to a geographic location of the repository.

### FIELD OF THE DISCLOSURE

The field of the disclosure relates generally to a secure delivery system and a method, and more particularly, to a system and a method that can be used to facilitate secure delivery of articles between senders and recipients.

### BACKGROUND OF THE DISCLOSURE

Most package delivery methods involve the use of a courier who can deliver package from a sender to a recipient. In general, the courier will deliver the package to a delivery location (e.g., a physical address) of the recipient, which may be the recipient's home or business location. Often, if the recipient is not present when the package is delivered, the courier will simply leave the package at the recipient's delivery location. In cases in which the delivery location is the recipient's home, the courier will often leave the package on the front stoop of the recipient's home.

Such a delivery method is fraught with potential error and opens the door for fraudulent actors to intercept the package. For instance, if the courier makes a mistake and delivers the package to an incorrect address, the intended recipient may never receive the package. Furthermore, even if the package is delivered to the correct address, if the package is left unattended (e.g., on the front stoop of the recipient's home), it is becoming prevalent for fraudulent actors thieves) to take notice of the unattended package and steal the package.

### BRIEF DESCRIPTION OF THE DISCLOSURE

This summary is not intended to identify essential features of the present invention, and is not intended to be used to limit the scope of the claims. These and other aspects of the present invention are described below in greater detail.

In one aspect, a secure delivery system for securely delivering an article between a sender and a recipient is provided. The secure delivery system includes a repository comprising a housing presenting an interior space. The repository is configured to securely hold one or more articles. The repository additionally includes a deposit hatch integrated with the repository and configured to provide selective access to the interior space of the repository. A first user interface is associated with the deposit hatch and configured to receive an instruction to permit the deposit hatch to open to provide access to the interior space of the repository. The secure delivery system additionally includes a retrieval hatch integrated with the repository and configured to provide selective access to the interior space of the repository. A second user interface is associated with the deposit hatch and configured to receive an instruction to permit the retrieval hatch to open to provide access to the interior space of the repository. The secure delivery system additionally includes a communications element configured to a transmit a delivery notification to the recipient. The delivery notification includes information the recipient can use to access a particular article held within the repository. The secure delivery system further includes an autonomous courier device configured to transport the one or more articles from a geographic location remote from the repository to the geographic location of the repository.

In another aspect, a secure delivery system for securely delivering an article between a sender and a recipient is provided. The secure delivery system includes a repository comprising a housing presenting an interior space and that is configured to securely hold one or more articles. The secure delivery system additionally includes a hatch integrated with the repository and configured to provide selective access to the interior space of the repository. A user interface is associated with the hatch and configured to receive an instruction to permit the hatch to open to provide access to the interior space of the repository. The secure delivery system further includes a main computing device associated with the repository. The main computing device comprises a non-transitory computer readable storage media with a computer program stored thereon. The computer program instructs a processing element of the main computing device to perform a number steps. A first step includes receiving an indication that an article has been received in the repository. An additional step includes generating a delivery notification. An additional step includes transmitting the delivery notification to a user computing device of the recipient. An additional step includes receiving, via the user interface, an instruction to provide the recipient with access to the article received in the repository. A further step includes permitting the hatch to open to provide the recipient with access to the article received in the repository.

In yet another aspect, a secure delivery method for securely delivering an article between a sender and a recipient is provided. The secure delivery method comprises a number of steps. One step includes providing a repository for securely holding one or more articles. The repository comprises a housing presenting an interior space, a hatch integrated with the housing and configured to provide selective access to the interior space, and a user interface associated with the hatch and configured to receive an instruction to permit the hatch to open to provide access to the interior space. An additional step includes receiving an article into the interior space of the repository. An additional step includes generating, via a processor, a delivery notification corresponding to the received article. An additional step includes transmitting, via a communications element, the delivery notification to a computing device of the recipient. An additional step includes receiving, via the user interface of the repository, an instruction to provide the recipient with access to the article received in the repository. An additional step includes shifting the hatch to an open position. A further step includes dispensing the article to the recipient via the hatch.

### BRIEF DESCRIPTION OF THE DRAWINGS

Embodiments of the present invention are described in detail below with reference to the attached drawing figures, wherein:

FIG. 1 is schematic illustration of a secure delivery system according to embodiments of the present invention;

FIG. 2 is a perspective view of a repository from the secure delivery system of FIG. 1;

FIG is a block diagram of exemplary components of the repository from FIG. 2;

FIG. 4 is a block diagram of exemplary computing devices from the secure delivery system of FIG. 1;

FIG. 5 is a block diagram of an exemplary autonomous courier device from the secure delivery system of FIGS. 1; and

FIG. 6 is a flowchart of a method for securely delivering an article from a sender to a recipient according to embodiments of the present invention.

The figures are not intended to limit the present invention to the specific embodiments they depict. The drawings are not necessarily to scale, Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to validating payment transactions made using payment network systems. However, the scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, operation, etc. described in one embodiment may also be included in other embodiments, but is not necessarily included. Thus, particular implementations of the present invention can include a variety of combinations and/or integrations of the embodiments described herein.

### System

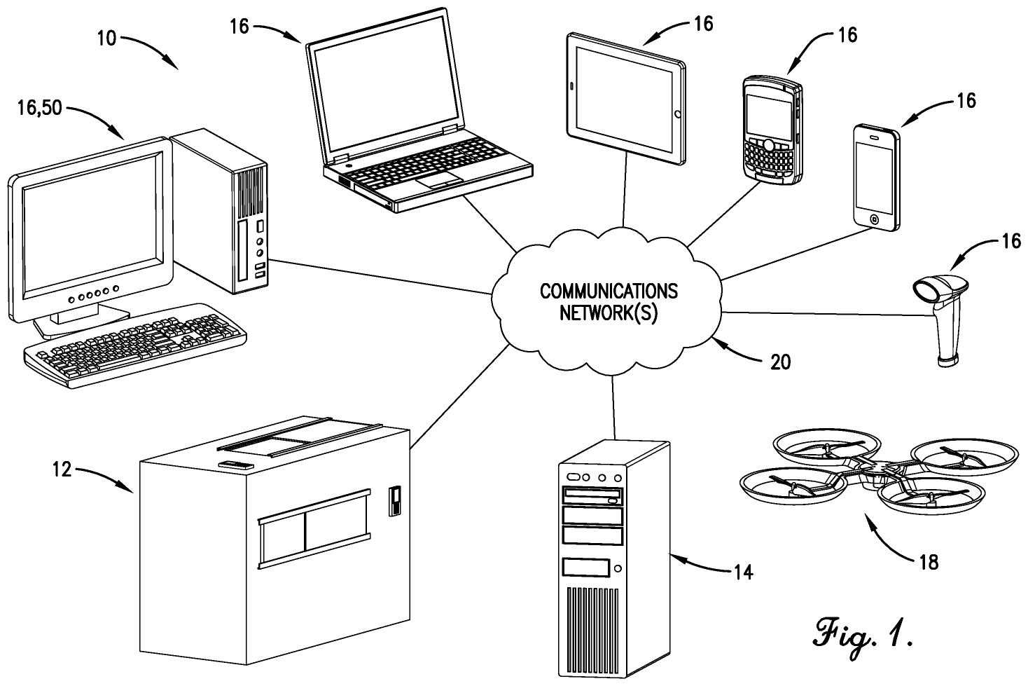

Broadly characterized, the present invention relates to a delivery system and method, which may be used to facilitate secure delivery of articles between senders and recipients. FIG. 1 illustrates a secure delivery system 10 according to embodiments of the present invention, which may include a repository 12 for securely storing articles, such as packages, which are being delivered from a sender to a recipient. The secure delivery system 10 may additionally comprise one or more server devices 14 and one or more user computing devices 16. As will be described in more detail below, the user computing devices 16 may be used to implement embodiments of the present invention by various users of the secure delivery system 10, such as a delivery service, senders of articles, recipients of articles, and/or couriers of articles. In some embodiments, the secure delivery system 10 may alternatively include one or more courier devices 18, such as unmanned aerial vehicles (UAVs) or drones, which can be used to transport articles instead of individual couriers (i.e., human couriers). Each of the components of the secure delivery system 10, e.g., the repository 12, the server device 14, the user computing devices 16, and/or the courier device 18, may be in communication with each other via a communications network 20.

Although the articles described herein generally refer to delivery-type packages in which objects are held or enclosed within containers for delivery (e.g., objects held within boxes, envelopes, or the like), articles may also include various other objects that are not necessarily held or enclosed within containers. Nevertheless, embodiments generally provide for a sender (or a courier working on behalf of a delivery service for the sender) to deliver an article to the repository 12 for secure storage. The repository 12 of embodiments of the present invention is configured to securely store the article until an intended recipient arrives at the repository 12 and retrieves the article stored therein. As such, embodiments of the secure delivery system 10 can be used to ensure that articles are accurately and securely transferred from a sender to an intended recipient, as will be discussed in more detail below.

As illustrated in FIG e repository 12 may broadly comprise a housing, with a front side, a back side, a bottom side, a top side, and a pair of lateral sides, which are configured to cooperatively enclose an interior space. As will be described in more detail below, the repository 12 is configured to securely hold one or more articles within the interior space. As such, the repository 12 may be formed in various sizes, as may be necessary to securely store a required number of articles and/or articles of particular sizes. The repository 12 may be generally sealed from the outside environment, such that objects that are stored within the interior space are protected from precipitation, extreme temperature, and the like.

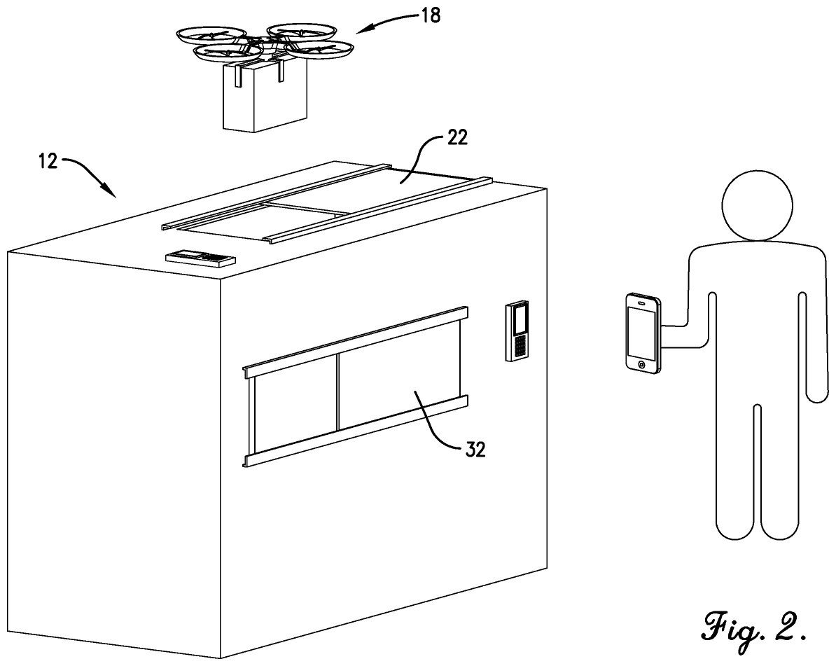

With reference to FIG. 2, the repository 12 may include at least one deposit hatch 22, which may be used as an access portal to provide selective access from outside the repository 12 to the interior space. As such, the deposit hatch 22 may be used to deposit articles into the repository 12. In some embodiments, the deposit hatch 22 may be a door, which is hingedly or slidably connected to one of the sides of the housing of the repository 12. In some embodiments, the deposit hatch 22 may be integrated with the top side of the housing of the repository 12. Nevertheless, in other embodiments, the deposit hatch 22 may be integrated with other sides or portions of the housing, such as within the back side of the housing of the repository 12. As illustrated in FIG. 2, in some embodiments, the repository 12 may include a single deposit hatch 22. However, in other embodiments, the repository 12 may include multiple deposit hatches 22.

As shown in FIG. 3, the deposit hatch 22 may be associated with a locking mechanism 24 that is configured to selectively lock and unlock the deposit hatch 22 with respect to the repository 12. When the locking mechanism 24 is in a locked state, the deposit hatch 22 can be maintained in a closed position, such that access to the interior space of the repository 12 from the deposit hatch 22 is restricted. When the locking mechanism 24 is shifted to the unlocked state, the deposit hatch 22 is permitted to be opened, so as to provide access to the interior space of the repository 12. In some embodiments, the locking mechanism 24 may comprise a mechanical lock, such as door lock or deadbolt. In such embodiments, the locking mechanism 24 of the deposit hatch 22 may be unlocked using a mechanical key. In other embodiments, the locking mechanism 24 may comprise an electro-mechanical lock. In such embodiments, the deposit hatch 22 may be unlocked using a user interface 26 associated with the deposit hatch 22, which may also be integrated with the repository 12 (e.g., integrated within the housing of the repository 12 at a position adjacent to the deposit hatch 22). Such a user interface 26 may, for instance, comprise a keypad, a touchscreen, a key-card reader, an optical scanner, a laser scanner, a biometric scanner (e.g., thumbprint scanner, retinal scanner, microphone/voice scanner, etc.), a digital/video camera, a radio-frequency identification (RFID) reader, an near-field communication (NFC) reader, a proximity sensor, or the like, which may be used to unlock the locking mechanism of the deposit hatch 22. As such, a courier (or a courier device 18) may unlock and permit opening of the deposit hatch 22, via the user interface 26, to gain access to the interior space of the repository 12 so as to deliver an article within the repository 12. In some embodiments, the deposit hatch 22 may be associated with an opening mechanism, which is configured to automatically shift the deposit hatch 22 from a closed position into an open position once the locking mechanism 24 has unlocked the deposit hatch 22.

In additional embodiments, the repository 12 may include at least one retrieval hatch 32, as shown in FIG. 2, which may be used as an access portal to provide access from outside the repository 12 to the interior space. As such, the retrieval hatch 32 may be used to extract articles from within the repository 12. In some embodiments, the retrieval hatch 32 may be a door, which is hingedly or slidably connected to one of the sides of the housing of the repository 12. In some embodiments, the retrieval hatch 32 may be integrated with the front side of the housing of the repository 12. Nevertheless, in other embodiments, the retrieval hatch 32 may be integrated with other sides or portions of the housing of the repository 12. In some embodiments, the repository 12 may include a plurality or retrieval hatches 32. However, in other embodiments, the repository 12 may include only a single retrieval hatch 32. In still further embodiments, the repository 12 may include only a single access portal, such that a single access portal operates as both the deposit hatch 22 and the retrieval hatch 32.

As with the deposit hatch 22, and with reference to FIG. 3, the retrieval hatch 32 may be associated with a locking mechanism 34 that is configured to selectively lock and unlock the retrieval hatch 32 with respect to the repository 12. When the locking mechanism 34 is in a locked state, the retrieval hatch 32 can be maintained in a closed position, such that access to the interior space of the repository 12 from the retrieval hatch 32 is restricted. When the locking mechanism 34 is shifted to the unlocked state, the retrieval hatch 32 is permitted to be opened, so as to provide access to the interior space of the repository 12. In some embodiments, the locking mechanism 34 may comprise an electro-mechanical lock. In such embodiments, the retrieval hatch 32 may be unlocked using a user interface 36 associated with the retrieval hatch 32 (e.g., integrated within the repository 12 at a position adjacent to the retrieval hatch 32). Such user interface 36 may, for instance, include a keypad, a touchscreen, a key-card reader, an optical scanner, a laser scanner, a biometric scanner (e.g., thumbprint scanner, retinal scanner, microphone/voice scanner, etc.), a digital/video camera, an REID reader, an NEC reader, a proximity sensor, or the like, which may be used to unlock the locking mechanism 34 of the retrieval hatch 32. As such, a recipient may use the user interface 36 to unlock and permit the opening of the retrieval hatch 32 to gain access to the interior space of the repository 12 so as to retrieve an article stored within the repository 12. In some embodiments, the retrieval hatch 32 may be associated with an opening mechanism, which is configured to automatically shift the retrieval hatch 32 into an open position once the locking mechanism 34 has unlocked the retrieval hatch 32.

In embodiments of the secure delivery system 10 that only include a single hatch (e.g., a single hatch is used for both the deposit hatch 22 and the retrieval hatch 32), the repository 12 may include only a single user interface (e.g., user interface 26, 36) for controlling operation of the hatch. In still other embodiments, such as embodiments that include both the deposit hatch 22 and the retrieval hatch 32, the repository 12 may nonetheless include only a single user interface for controlling operation of both the deposit hatch 22 and the retrieval hatch 32.

The repository 12 may, in some embodiments, additionally comprise a sorting assembly 40, which may be integrated within the repository 12. The sorting assembly 40 may comprise a robotic arm, a conveyor system, a rotating table or wheel (e.g., with bins for holding articles), and/or various other mechanisms (all of which are not shown) configured to accept articles deposited into the repository 12 (e.g., via the deposit hatch 22) and to place or sort the articles into specified positions within the interior space of the repository 12 so that the repository 12 can securely hold and sort the articles that it receives. In addition, the sorting assembly 40 may be configured to transfer the articles from their specified positions within the repository 12 to the retrieval hatch 32, such that a recipient can retrieve his/her article from the repository 12.

In more detail, the sorting assembly 40 may, in some embodiments, comprise a robotic arm. Upon an article being delivered to the repository 12, the robotic arm may accept the article, e.g., from the deposit hatch 22, and place the article within the repository 12 at specific position for secure storage. Once a recipient arrives at the repository 12 to retrieve the article, the robotic arm may transfer the article from its specific position within the repository to the retrieval hatch 32, such that the recipient can retrieve the article from the repository 12. In certain embodiments, the repository 12 may be configured with multiple retrieval hatches 32. In such embodiments, the robotic arm may place each article deposited within the repository 12 into a bin associated with an assigned retrieval hatch 32. As such, when a recipient arrives at the repository 12 to retrieve the recipient's particular article, the recipient may simply open the assigned retrieval hatch 32 associated with recipient's particular article so as to retrieve the article.

In addition to the robotic arm described above, the sorting assembly 40 may alternatively (or in addition) comprise various other types of mechanisms configured to (1) accept articles into the repository 12 via the deposit hatch 22, (2) sort the articles for storage in the repository 12, and (3) dispense the articles from the repository 12 via the retrieval hatch 32. As noted above, such alternative sorting assemblies 40 may comprise various mechanisms, such as conveyor systems (e.g., conveyor bels), rotating wheels or tables (e.g., with bins for holding articles), or the like.

To provide power (e.g., electrical power) to the various components of the repository 12, the repository 12 may, in some embodiments, have a dedicated power source 46. In some embodiments, the power source 46 may simply comprise a connection to available mains power. For instance, in some embodiments, the repository 12 may be positioned within a parking lot of a shopping center. In such instances, the repository 12 may tap into an available mains power to use such available power as a power source 46. In certain embodiments, the power source 46 may also include one or more rechargeable batteries. In such embodiments, the rechargeable batteries may be periodically charged by various methods, such as via available mains power. In still further embodiments, the repository 12 may be associated with various renewable energy sources, such as solar panels, which may be used to recharge the rechargeable batteries.

Finally, the repository 12 may additionally comprise a main computing device 50, which may be integrated within the repository 21. The main computing device 50 can be used to control various functions and features of the repository 12, as will be described in more detail below. For example, the repository 12 may be used to control operation of the deposit hatch 22 and the retrieval hatch 32, including their respective locking mechanisms 24, 34 and user interfaces 26, 36 (and opening mechanisms, if provided). The main computing device 50 may be configured to store and execute a computer program that performs certain functionalities of the repository 12 and/or certain other functions of the secure delivery system 10 described elsewhere herein.

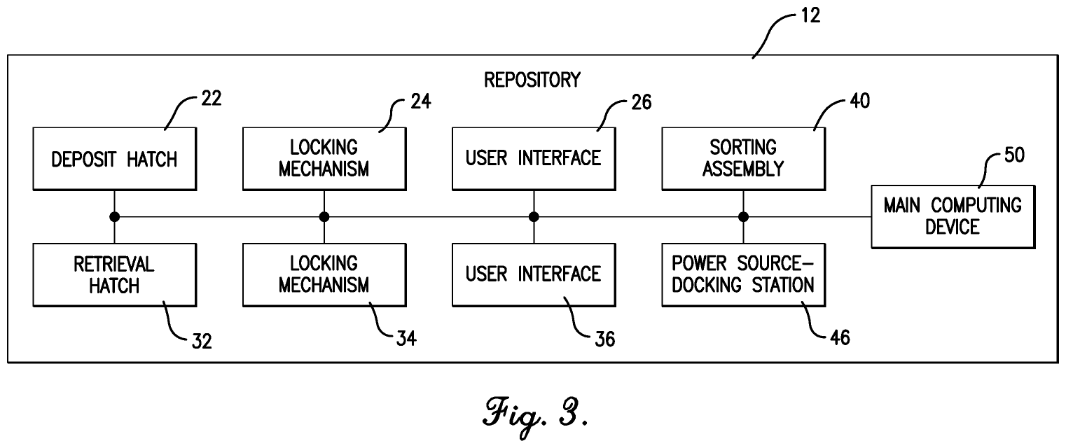

As illustrated in FIG. 4, the main computing device 50 may include any device, component, or equipment with processing elements and associated memory elements. The processing elements may implement operating systems, and may be capable of executing computer programs, which are also generally known as instructions, commands, software code, executables, applications, apps, and the like. The processing elements may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™ and the like, or combinations thereof.

In certain specific embodiments, the main computing device 50 may comprise work stations, desktop computers, laptop computers, tablet computers, and the like, or combinations thereof. In some embodiments, the main computing device 50 may have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI can enable users to interact with the electronic display by touching or pointing at display areas to provide information to the user control interface, which discussed in more detail below. In some embodiments, the electronic display may present on the exterior of the repository 12, such that users can interact with the graphic display from outside the repository 12. In some embodiments, for instance, the electronic display of the main computing device 50 may be used to form the user interfaces 26, 36 associated with the deposit hatch 22 and/or the retrieval hatch 32.

Furthermore, the main computing device 50 may include the appropriate communication elements to establish a wired or a wireless connection, via the communications network 20, as discussed in more detail below. For example, the main computing device 50 may include, a wired or wireless network adapter or a wireless data transceiver. The wireless transceiver may be configured for use with wireless networks, such as WiFi, WIMAX, or Bluetooth, or for use with a mobile data network or mobile phone network, such Global System for Mobile communications (GSM), 3G, or 4G.

In some embodiments, the secure delivery system 10 may additionally comprise the server device 14, which may, in some embodiments, be positioned remotely from the repository 12. For instance, the server device 14 may be hosted at a service provider facility, with such service provider offering embodiments of the secure delivery system 10 to facilitate the transfer of articles between senders and recipient. The server device 14 may be configured to store and execute portions of the computer program that perform certain functions and features of the secure delivery system 10 described herein.

As also illustrated in FIG. 4, the server device 14 may include one or more computing devices that provide access to various general computing resources, such as Internet services, data transfer services, data storage services, and the like. The server device 14 may also provide access to a database that stores information related to the secure delivery system 10 of embodiments of the present invention. The database may also store other information and data necessary for the implementation of the computer program and method of embodiments of the present invention.

In general, the server device 14 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server device 14 may further include file stores comprising a plurality of hard disk drives, network attached storage, or a separate storage network.

The server device 14 may include the appropriate communication elements to establish a wired or a wireless connection, via the communications network 20, as discussed in more detail below. For example, the sever device 14 may include, a wired or wireless network adapter or a wireless data transceiver. The wireless transceiver may be configured for use with wireless networks, such as WiFi, WIMAX, or Bluetooth, or for use with a mobile data network or mobile phone network, such Global System for Mobile communications (GSM), 3G, or 4G.

Turning to the user computing devices 16, such devices may include generally any type of computing device that can be operated by individual users such as senders of articles, recipients of articles, and couriers of articles. As such, the user computing devices 16 may be configured to store and execute a computer program that performs certain functionalities of the secure delivery system 10 as described elsewhere herein.

As also illustrated in FIG. 4, the user computing devices 16 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™ and the like, or combinations thereof.

In certain specific embodiments, the user computing devices 16 may specifically include mobile communication devices (including wireless devices), work stations, desktop computers, laptop computers, palmtop computers, tablet computers, portable digital assistants (PDA), smart phones, optical or data scanners (e.g., barcode or Quick Response (QR) code scanners) and the like, or combinations thereof. In preferred embodiments, the computing devices 16 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional embodiments, the user computing devices 16 may include an optical device such as a digital camera, video camera, optical scanner, or the like, such that the computing device can capture, store, analyze, and/or transmit digital images and/or videos.

The user computing devices 16 may include a control interface that enables one or more users to share information and commands with the user computing devices 16. The control interface may comprise one or more functionable inputs such as buttons, keyboard, switches, scrolls wheels, voice recognition elements such as a microphone, pointing devices such as mice, touchpads, tracking balls, styluses. The control interface may also include a speaker for providing audible instructions and feedback. Further, the control interface may comprise wired or wireless data transfer elements, such as a communication component, removable memory, data transceivers, and/or transmitters, to enable the user and/or other computing devices to remotely interface with the user computing device 16. In additional embodiments, the user computing devices 16 may be associated with location-determining elements, such as global-positioning system (GPS) components, accelerometers, or the like, or combinations thereof.

The user computing devices 16 may also include the appropriate communication elements to establish a wired or a wireless connection, via the communications network 20, as discussed in more detail below. For example, the user computing devices 16 may include, for a wired or wireless network adapter or a wireless data transceiver. The wireless transceiver may be configured for use with wireless networks, such as WiFi, WIMAX, or Bluetooth, or for use with a mobile data network or mobile phone network, such Global System for Mobile communications (GSM), 3G, or 4G.

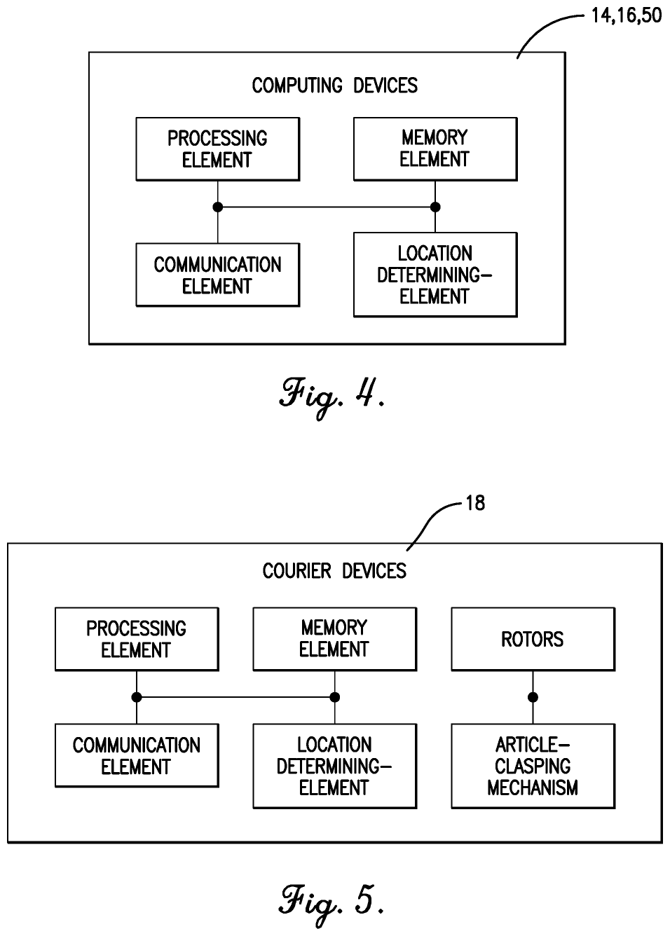

Certain embodiments of the secure delivery system 10, may additionally include a courier device 18, as illustrated in FIG. 5, which is configured to transport one or more articles. As illustrated in FIGS. 1 and 2, the courier device 18 may comprise an autonomously-operated vehicle, such as an aerial drone. The courier device 18 may include one or more computing devices, which may include processing elements and memory elements, for controlling the functionality of the courier device 18. The courier device 18 may be configured to store and execute a computer program that permits certain functions of the courier device 18 as described elsewhere herein.

As shown in FIGS. 1 and 2, the courier device 18 may be in the form of an autonomous aerial drone, which can be kept aloft and flown between geographic locations through lift provided by a number of rotors. In some embodiments, each of the rotors may be powered by an electric motor, which derives its own power from a power source, such as an on-board rechargeable battery. In such embodiments, the autonomous drone may include a charging adapter, which is configured to engage with a separate power source, such as a charging station, for charging the power source of the autonomous drone. As such, when the autonomous drone is flown into engagement with such a charging station, the charging station can recharge the power source of the autonomous drone via the autonomous drone's power adapter. The courier device 18 may additionally comprise an article-clasping mechanism, which can be configured to grasp and securely hold an article when travelling between geographic locations.

The courier device 18 may also include appropriate communication elements to establish communication connection (wired or wireless), via the communications network 20, as discussed in more detail below. For example, the courier device 18 may include a wireless data transceiver. The wireless transceiver may be configured for use with wireless networks, such as Win, WIMAX, or Bluetooth, or for use with a mobile data network or mobile phone network, such Global System for Mobile communications (GSM), 3G, or 4G. To guide the courier device 18 between geographic locations or positions, the courier device 18 may also include one or more location-determining elements, such as GPS devices, accelerometers, or the like, or combinations thereof As such, the courier device 18 can autonomously transport articles between one or more geographic locations as instructed. Although the courier device 18 is described herein as an autonomous drone, the courier device 18 may comprise other types of autonomous vehicles, such as autonomous ground-driving vehicles (e.g., self-driving cars), autonomous nautical vehicles, or the like.

Each of the components of the secure delivery system 10 may be configured to communicate with each other through the communications network 20. The communications network 20 may be wired or wireless and may include servers, routers, switches, wireless receivers and transmitters, and the like, as well as electrically conductive cables or optical cables. The communications network 20 may also include local, metro, or wide area networks, as well as the Internet, or other cloud networks. Furthermore, the communications network 20 may include cellular or mobile phone networks, as well as landline phone networks, public switched telephone networks, fiber optic networks, or the like. As such, each of the components of the secure delivery system 10 may have the necessary communications devices to enable communication through the communications network 20. For example, the main computing device 50 may be able to communicate with various user computing devices 16 through the communications network 20. Likewise, the user computing devices 16 may be able to communicate with the main computing device 50 through the communications network 20. Nevertheless, it should be understood that each of the components of the secure delivery system 10 (e.g., the main computing device 50, the server devices 14, the user computing devices 16, and/or the courier devices 18) may be configured to communicate with each of the other components. Thus, these components will generally include the necessary equipment (e.g., transceivers) required to facilitate such communication, which may be wired or wireless.

As noted above, certain functions and features of the secure delivery system 10 may be performed by one or more computer programs executed from components of the secure delivery system 10, such as from the main computing device 50, the server devices 14, the user computing devices 16, and/or the courier devices 18. The computer program(s) of embodiments of the present invention may be implemented via hardware, software, firmware, or combinations thereof.

The computer program of the present invention may run on the main computing device 50 of the repository 12 or, alternatively or in conjunction, may run on one or more user computing devices 16, the server device 14, and/or the courier device 18. Thus, a first portion of the program, code, or instructions may execute on the main computing device 50, while a second portion of the program, code, or instructions may execute on a user computing device 16, a server device 14, and/or a courier device 18. In some embodiments, other portions of the program, code, or instructions may execute on other components of the secure delivery device 10 as well. For example, information related to the secure delivery system 10 may be stored on a memory element associated with the main computing device 50 and/or the server device 14, such that the information is remotely accessible to users of the computer program via the user computing devices 16. Alternatively, certain information may be directly stored on the memory elements associated with the user computing devices 16 of the user. As such, the various functions, features, actions, and calculations described herein as being performed by or using the computer program may actually be performed by one or more computers, processors, or other computational devices, such as the main computing device 50, the user computing devices 16, the server device 14, and/or the courier device 18, independently or cooperatively executing portions of the computer program.

In embodiments in which the computer program, or portions thereof, is stored and executed from the user computing devices 16, the computer program may be embodied in a stand-alone program downloaded on the user computing devices 16 or in a web-accessible program that is accessible by the user computing devices 16 via the communications network 20. For the stand-alone program, a downloadable version of the computer program may be stored, at least in part, on the server device 14, A user can download at least a portion of the computer program onto a user computing device 16 of the user via the communications network 20. In such embodiments of the present invention, the computer program may be an “application,” such as an “app” for a mobile device. After the computer program has been downloaded, the program can be installed on the user computing device 16 in an executable format. The executable form of the program permits the user to access embodiments of the present invention via an electronic resource, such as a mobile “app” or website. For the web-accessible computer program, the user may simply access the computer program via the communications network 20 (e.g., the Internet) with the user computing device 16, As such, the stand-alone computer program or web-accessible program provides users with access to an electronic resource from which the users can interact with various embodiments of the present invention.

In some embodiments, users of the secure delivery system 10 will be required to create user accounts with which to access certain functions and features of secure delivery system 10 via their user computing devices 16. Such user accounts may require the users to provide usernames and passwords with which the users can access their user accounts. In other embodiments, the users may be assigned a username and password. In additional embodiments, the users may be required to provide identification information, which can be associated with their user accounts. Such identification information may include the user's legal name, physical address, email address, telephone number, biometric information (e.g., thumb print, retinal scan, etc.), or other similar types of information. As will be described in more detail below, such identification information may be used to provide notifications to users, as well as to identify geographic locations for pickup and delivery of articles being delivered via the secure delivery system 10.

Operation of embodiments of the secure delivery system 10 will be described in more detail below. Certain of such below-described steps may be performed via one or more computing devices (e.g., the main computing device 50, the user computing devices 16, the server devices 14, and/or the courier device 18) executing the computer program of embodiments of the present invention. According to other embodiments, however, certain of such steps may be performed by other components of the secure delivery system 10 or other individuals, as well.

### Operation

In operation, the secure delivery system 10 can be used to facilitate secure delivery of articles (e.g., packages) between senders and recipients. In more detail, the repository 12 can be used to receive an article sent by a sender and to securely hold the article until a recipient arrives at the repository 12 to retrieve the article. Generally, the repositories 12 may be positioned in safe, public areas, such as in shopping center parking lots, police station parking lots, or the like. Use of the repository 12 will help ensure that an article is delivered to the correct geographic location and will be securely held at such geographic location until the intended recipient retrieves the article. As such, senders and recipients can be assured that their articles will not be mis-delivered and/or that the articles will not be delivered and left unattended to potentially be stolen by fraudulent actors.

To begin, in some embodiments, the sender may be an individual that is mailing a package to the recipient via a delivery service, such as the US Postal Service (USPS), FedEx, UPS, or the like. In such embodiments, the sender may bring the article to a geographic location of an office of the delivery service (e.g., to a USPS office). In alternative embodiments, the sender may contact the delivery service or another service provider, such as through an online resource e.g., Internet or a mobile app) made available via the sender's user computing device 16. The sender may, via the online resource, instruct the delivery service to pick up the article from the sender's current geographic location and/or at the sender's home address. The sender may also provide a time at which the sender wishes for the delivery service to pick up the article. In alternative embodiments, the delivery service may provide a time window in which the delivery service will pick up the article from the sender. In addition to the sender being an individual that intends to send an article to a recipient, the sender may be a retailer from which the recipient has purchased an article that must, then, be delivered to the recipient.

As noted previously, embodiments may provide for users to access the online resource of embodiments of the present invention using a user account. The user account may include various types of identification information, including the user's physical address, email address, telephone number, and the like. As such, the sender can instruct the delivery service to pick up the article at the sender's geographic location, which may be the sender's physical address that is included as part of the sender's identification information associated with the sender's user account. Alternatively, the sender can manually provide a geographic location at which to pick up the article. In further alternatives, the sender's geographic location may be automatically obtained from the location-determining element (e.g., UPS) of the sender's user computing device 16.

In addition to providing a pick-up location for the article, certain embodiments may require that the sender also provide information relating to where the article should be delivered so that the recipient can retrieve the article. As described above, the secure delivery system 10 includes the repository 12 for securely storing the article until such time as the recipient can retrieve the article. As such, the sender may be required to manually identify a particular repository 12, or a geographic location of a particular repository 12, that the sender would like the article to be sent. Alternatively, embodiments may automatically select a repository 12 based on the geographic location of the recipient. For example, if the sender enters the recipient's physical address, embodiments may automatically select the closest repository 12 to the recipient's physical address for delivery of the article. In further embodiments, the recipient may have a user account that is associated with identification information (including the recipient's physical address). In such cases, the sender may simply identify the recipient, and embodiments may automatically determine the repository that is closest to the recipient's physical address. In further alternatives, embodiments may determine a real-time geographic location of the recipient, via the location-determining element (e.g., GPS) of the recipient's user computing device 16, and may select the closest repository 12 to the recipient's current geographic location. In still further alternatives, embodiments may allow the recipient to associate a preferred repository 12 for receiving all articles that are being sent to the recipient. As such, if the sender indicates that the recipient is to be delivered an article, embodiments may automatically select the recipient's preferred repository 12 for delivery of the article.

Once the delivery service has obtained the article that is to be delivered, as well as the identification information of the recipient and/or the location of the intended repository 12 for delivery, the delivery service may, e.g., via the server device 14, generate and attach an identification tag or sticker, such as Universal Product Code (UPC) tag, onto the article. The identification tag (e.g., the UPC tag) may be associated with information indicative of (1) the article, (2) the sender (e.g., the sender's identification information), (3) the recipient (e.g., the recipient's identification information), and/or (4) the repository 12 to which the article is to be delivered. For example, such information may include the recipient's identification information, which may include the recipient's physical address, email address, telephone number, or the like. As will be described in more detail below, such information may be used to notify the recipient once the article has been successfully delivered to the repository. In some embodiments, once generated, the information that is associated with the identification tag may be stored on the main computing device 50 of the repository 12 to which the article is to be delivered. In such embodiments, the information associated with the identification tag may be transmitted to the main computing device 50 of the repository 12 from the server device 14.

Next, embodiments provide for the article to be delivered to the intended repository 12. In some embodiments, a courier, who may be an employee or contractor of the delivery service, may manually deliver the article to the repository 12. In such instances, once the courier arrives at the repository 12, the courier may approach the deposit hatch 22 and scan the identification tag from the article using the repository's 12 user interface 26 (e.g., using the optical scanner or laser scanner of the user interface 26). Upon scanning the identification tag, the deposit hatch 22 may be unlocked and opened (e.g., under control of the main computing device 50). The repository's 12 sorting assembly 40 may receive the article from the courier, via the deposit hatch 22, and securely position the article within the repository 12. In embodiments that include only a single retrieval hatch 32, the sorting assembly 40 may position the article at generally any position within the repository, as long as the sorting assembly 40 knows where the article is positioned for later retrieval when the recipient arrives to pick up the article. In embodiments in which the repository 12 includes multiple retrieval hatches 32, the sorting assembly 40 may position the article within a specific compartment or bin that is associated with a specific retrieval hatch 32. As such, when the recipient arrives at the repository 12, the recipient can simply open the specific retrieval hatch 32 (as discussed in more detail below) to retrieve the recipient's article from the specific compartment or bin. Regardless, once the article has been securely positioned by the sorting assembly 40 within the repository 12, the deposit hatch 22 may be shifted to the closed position and locked so as to securely store the article therein.

Upon the identification tag of the article being scanned at the repository 12, the main computing device 50 may retrieve the information associated with the identification tag (e.g., the recipient's identification information) either from its own memory elements or from the server device 14. At such time, the repository 12 may send, e.g., via the communication element of the main computing device 50, a delivery notification to the recipient, e.g., via the recipient's user computing device 16. Such a delivery notification may also be sent to the sender, e.g., via the sender's user computing device 16. The delivery notification may be sent via email, SMS text message, voicemail, the online resource (e.g., the mobile app or Internet application), or other similar method. In general, the delivery notification will include a message that indicates that the recipient's article has arrived at the repository 12. For the recipient, the delivery notification may also comprise retrieval instructions that include a geographic location of the repository 12 so that the recipient knows where to travel to retrieve the article. In addition, the retrieval instructions for the recipient may include a retrieval code, which the recipient can use to gain access to the repository 12 to retrieve the article. In some embodiments, the retrieval code may comprise a password (e.g., an alphanumeric code), a Quick Response (QR) code, or the like.

In alternate embodiments, however, the retrieval instructions sent to the recipient via the delivery notification may not include a retrieval code. In such alternate embodiments, the retrieval instructions may otherwise provide instructions for how the recipient can retrieve the article from the repository. For example, as will be described in more detail below, the retrieval instructions may include a description of how the recipient can use the recipient's user computing device 16 to communicate with the main computing device 50 and/or the user interface 36 (e.g., via NFC) so as to authenticate the recipient's identify for retrieving the recipient's article from the repository

Upon the recipient arriving at the repository, the recipient may approach the retrieval hatch 32 and may provide instructions to the repository 12 to obtain access to the article stored within. For instance, in embodiments in which the retrieval instructions sent to the recipient via the delivery notification included a retrieval code, the recipient may enter the retrieval code into the user interface 36 associated with the retrieval hatch 32. In embodiments in which the retrieval code comprises a QR code, the recipient may enter the retrieval code by displaying the QR code on the electronic display of the recipient's user computing device 16 and scanning the QR code using the repository's 12 user interface 36 (e.g., using the optical scanner). Upon scanning the retrieval code, the retrieval hatch 32 may be unlocked and opened (e.g., under automated control of the main computing device 50), and the sorting assembly 40 may retrieve the article from its position within the repository and dispense or otherwise make the article available to be retrieved by the recipient via the retrieval hatch 32. After retrieving the article from the repository 12, the retrieval hatch 32 may be shifted to the closed position and locked so as to secure the interior space of the repository.

In other embodiments, the retrieval instructions included within the delivery notification to the recipient may not include a retrieval code. In such embodiments, the retrieval instructions may include general instructions (e.g., a textual message), which the recipient can perform or execute to retrieve the recipient's article from the repository 12. For instance, the retrieval instructions may instruct the recipient, upon arriving at the repository 12, to provide authentication information to the repository 12, such that the repository 12 can authenticate the recipient's identity. As an example, the retrieval instructions may instruct the recipient to provide biometric information (e.g., a thumb print, a retinal scan, voice scan, etc.) via the recipient's user computing device 16. After providing the biometric information, such information may be transmitted from the recipient's user computing device 16 to the main computing device 50 of the repository 12 for verification. For instance, as described previously, the recipient's identification information may include biometric information. As such, the main computing device 50 can compare the biometric information received from the user computing device 16 with the biometric information associated with the recipient's user account. Upon verifying the recipient's identity, the repository 12 may provide for the retrieval hatch 32 to be unlocked and opened, and the sorting assembly 40 may retrieve the article from its position within the repository and make the article available to be retrieved by the recipient via the retrieval hatch 32. In other embodiments, the retrieval instructions may instruct the recipient to enter authentication information (e.g., biometric information) directly into the user interface 36 associated with the retrieval hatch 32.

In further alternatives, the recipient's user computing device 16 may itself be registered as belonging to the recipient. As such, the retrieval instructions sent to the recipient via the delivery notification may instruct the recipient to present the recipient's user computing device 16 to the repository 12 to authenticate the recipient's identification by analyzing information included within the presented user computing device 16. For example, when the recipient arrives at the repository 12, the recipient may position the recipient's user computing device 16 within NEC range of the user interface 36, such that the recipient's user computing device 16 can communicate, over NFC, with the user interface 36 and/or the main computing device 50 to authenticate the recipient's identity. Upon verifying the recipient's identity (e.g., by authenticating the recipient's user computing device 16 over NFC), the repository 12 may provide for the retrieval hatch 32 to be unlocked and opened, and the sorting assembly 40 may retrieve the article from its position within the repository and make the article available to be retrieved by the recipient via the retrieval hatch 32.

Once the recipient has retrieved the article, embodiments may provide for a retrieval notification to be transmitted to the sender. Such a retrieval notification may comprise an email, SMS text message, voicemail or the like, which can be transmitted to the sender's user computing device 16. The retrieval notification may comprise a message that generally verifies that the article was successfully retrieved by the intended recipient.

Given the above, the secure delivery system 10 can be used to securely deliver articles between senders and recipients. Specifically, the repository 12 can securely hold articles sent by a sender until such time that the intended recipient arrives at the repository to retrieve the article. As such, embodiments ensure that articles are not mis-delivered to an incorrect location (e.g., to an incorrect address). In addition, articles will be securely held within the repository 12 until the intended recipient retrieves the article, so as to not allow the opportunity for fraudulent actors to intercept and/or steal unattended articles.

In addition to embodiments in which couriers are used to deliver articles to repositories 12, embodiments may also use a courier device 18 to deliver articles. As previously described, the courier device 18 may be selected from various types of autonomous vehicles, such as autonomous aerial drones. In such embodiments, the courier device 18 may be instructed to pick up the article from the sender. For instance, the courier device 18 may be provided with the geographic location of the sender and may be instructed to travel to such geographic location to pick up the article. In such embodiments, the sender may be provided with an estimated time (e.g., via email, SMS text message, voicemail, or the like) for the drone to pick up the article. After picking up the article, the courier device 18 may be instructed to travel to a repository 12 to drop off the article for secure storage until the recipient can pick up the article.

Such a process of dropping the article off at the repository may be substantially the same as that previously described for the individual courier. For example, the courier device 18 may bring the article to within a scanning range of the user interface 26 of the deposit hatch 22, such that the user interface 26 can scan the UPC tag of the article and the deposit hatch 22 can be opened for depositing of the article. In alternative embodiments, NFC technology may be used, such that once the courier device 18 is within range of the deposit hatch 22, the deposit hatch automatically opens to receive the article. Upon the article being dropped off, embodiments may provide for both the sender and the recipient to be provided with a delivery notification reporting the successful drop off to the repository 12. In the case of the recipient, such delivery notification may include the retrieval code, as discussed above.

As noted previously, in some embodiments, the courier device 18 may be instructed as to which repository 12 to travel. In other embodiments, the courier device 18 may have a limited range. For instance, the courier device 18 may generally be powered by its own internal power source, which may comprise a rechargeable electric battery. As such, the courier device may have a limited range of travel. In such embodiments, after the courier device 18 picks up an article from a sender, the courier device 18 may select a repository 12 to deliver the article that is within the maximum travel range of the courier device 18.

In some embodiments, the courier device 18 may be configured to be recharged periodically during its travel. Such recharging may be made available via the secure delivery system 10. In particular, each repository 12 may include a charging station integrated with or positioned near the repository 12. For instance, the charging station may be located on the top side of the repository 12. The charging station may be associated with the power source 46 of the repository 12. As such, the charging station may be configured such that the courier device 18 can engage with the charging station (e.g., upon landing on the top side of the repository) and the charging station can transfer electrical charge from the power source 46 of the repository 12 to the courier device 18. For instance, after the courier device 18 has traveled to a repository 12 to deliver an article, the courier device 18 may engage with the charging station of the repository 12 so as to re-charge the power source of the courier device 18. As a result, the courier device 18 can travel from the repository 12 to pick up other articles and to deliver such other articles to other repositories 12, if each repository 12 includes a charging station, such a process can continue indefinitely, with the courier device 18 not being required to deviate from its mission of picking up and delivering articles to repositories 12. In additional embodiments, the courier devices 18 can extend their travel ranges by intermittently stopping and recharging their power sources at available repositories 12. As such, a given courier device 18 can deliver an article to a repository 12 that is beyond its maximum travel range by periodically stopping to recharge its power source at other repositories 12 during travel.

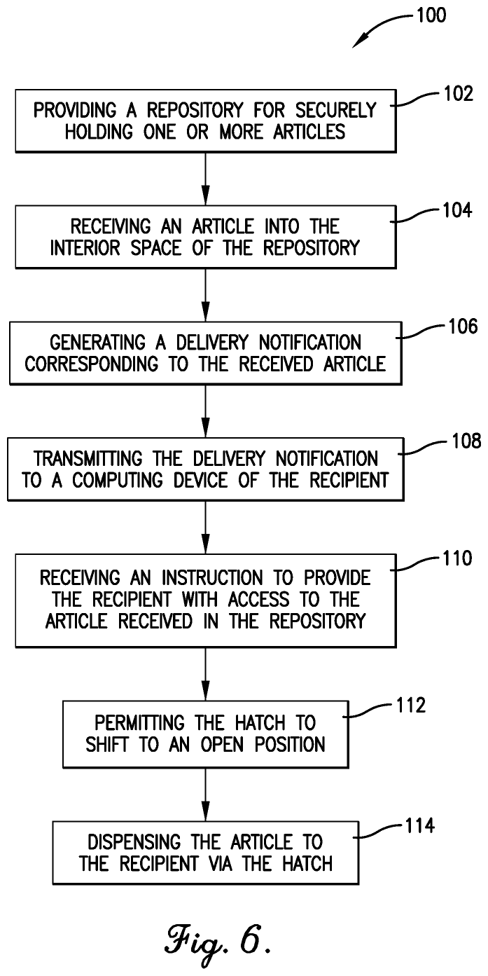

In view of the above, embodiments of the present invention include a secure delivery method 100, as illustrated in FIG. 6, for securely delivering an article between a sender and a recipient. A Step 102 of the method 100 includes providing a repository for securely holding one or more articles. The repository comprises a housing presenting an interior space, a hatch integrated with the housing and configured to provide selective access to the interior space, and a user interface associated with the hatch and configured to receive an instruction to permit opening of the hatch to provide access to the interior space. An additional Step 104 includes receiving an article into the interior space of the repository. An additional Step 106 includes generating, via a processor, a delivery notification corresponding to the received article. An additional Step 108 includes transmitting, via a communications element, the delivery notification to a computing device of the recipient. An additional Step 110 includes receiving, via the user interface of the repository, an instruction to provide the recipient with access to the article received in the repository. An additional Step 112 includes permitting the hatch to shift to an open position. A further Step 114 includes dispensing the article to the recipient via the hatch.

The operations, processes, and methods described herein may be carried out using a computer program stored on and executed on one or more computing devices. Specifically, a computer-readable storage media or medium comprising a non-transitory medium may include an executable computer program stored thereon. The computer program preferably instructs one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (AMC), logic circuits, and any other circuit or processor capable of executing the functions described herein. The above examples are illustrative only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above described memory types are examples only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication element,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory,” “memory area,” “memory element,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A secure delivery system for securely delivering an article between a sender and a recipient, said secure delivery system comprising:
a repository comprising a housing presenting an interior space, wherein said repository is configured to securely hold one or more articles;
a deposit hatch integrated with said repository and configured to provide selective access to the interior space of said repository;
a first user interface, wherein said first user interface is associated with said deposit hatch and configured to receive an instruction to permit said deposit hatch to open to provide access to the interior space of said repository;
a retrieval hatch integrated with said repository and configured to provide selective access to the interior space of said repository;
a second user interface, wherein said second user interface is associated with said deposit hatch and configured to receive an instruction to permit said retrieval hatch to open to provide access to the interior space of said repository;
a communications element configured to transmit a delivery notification to the recipient, wherein the delivery notification includes information the recipient can use to access a particular article held within said repository; and
an autonomous courier device configured to transport the one or more articles from a geographic location remote from said repository to a geographic location of said repository.

2. The system in accordance with claim 1, wherein the system is configured to automatically open said retrieval hatch upon receiving the instruction to permit said retrieval hatch to open.

3. The system in accordance with claim 1, wherein said first user interface comprises an optical scanner.

4. The system in accordance with claim 3, wherein each article is provided with a Universal Product Code (UPC) tag, and wherein the instruction to permit said deposit hatch to open comprises information read by the optical scanner from the UPC tag.

5. The system in accordance with claim 1, wherein the information the recipient can use to access the particular article is included within the delivery notification and comprises a retrieval code.

6. The system in accordance with claim 5, wherein the retrieval code comprises a Quick Response (QR) code, and wherein said communications element is configured to transmit the QR code to a computing device of the recipient.

7. The system in accordance with claim 6, where said communications element is configured to transmit the QR code to the computing device of the recipient via text message.

8. The system in accordance with claim 6, wherein said second user interface comprises an optical scanner, and wherein the instruction to permit said retrieval hatch to open comprises the optical scanner scanning the QR code transmitted to the computing device of the recipient.

9. The system in accordance with claim 1, wherein said repository further comprises a sorting assembly for accepting articles from said deposit hatch and for positioning the articles within the interior space of said repository.

10. The system in accordance with claim 9, wherein said sorting assembly is further configured to dispense the articles from the repository through the retrieval hatch.

11. The system in accordance with claim 9, wherein said sorting assembly comprises a robotic arm.

12. The system in accordance with claim 1, wherein said autonomous courier device comprises an aerial drone.

13. The system in accordance with claim 12, wherein said repository further comprises an electrical charging station, and wherein upon said aerial drone delivering an article to said repository, said drone is configured to be recharged by docking with said electrical charging station.

14. A secure delivery system for securely delivering an article between a sender and a recipient, said secure delivery system comprising:
a repository comprising a housing presenting an interior space, wherein said repository is configured to securely hold one or more articles;
a hatch integrated with said repository and configured to provide selective access to the interior space of said repository;
a user interface, wherein said user interface is associated with said hatch and configured to receive an instruction to open said hatch to provide access to the interior space of said repository; and
a main computing device associated with said repository, wherein said main computing device comprises a non-transitory computer readable storage media with a computer program stored thereon, wherein the computer program instructs a processing element of said main computing device to perform the following steps—
receive an indication that an article has been received in the repository,
generate a delivery notification,
transmit the delivery notification to a user computing device of the recipient,
receive, via the user interface, an instruction to provide the recipient with access to the article received in the repository,
permit the hatch to open to provide the recipient with access to the article received in the repository

15. The system in accordance with claim 14, wherein the user interface comprises an optical scanner, wherein the delivery notification comprises a Quick Response (QR) code, and wherein the step of receiving the instruction to provide the recipient with access comprises the user presenting the QR code to the user interface.

16. A secure delivery method for securely delivering an article between a sender and a recipient, said secure delivery method comprising the steps of:
providing a repository for securely holding one or more articles, wherein the repository comprises a housing presenting an interior space, a hatch integrated with the housing and configured to provide selective access to the interior space, and a user interface associated with the hatch and configured to receive an instruction to permit the hatch to open to provide access to the interior space;
receiving an article into the interior space of the repository;
generating, via a processor, a delivery notification corresponding to the received article;
transmitting, via a communications element, the delivery notification to a computing device of the recipient;
receiving, via the user interface of the repository, an instruction to provide the recipient with access to the article received in the repository;
permitting the hatch to shift to an open position; and
dispensing the article to the recipient via the hatch.

17. The method in accordance with claim 16, wherein the step of receiving the article further includes docking an autonomous aerial drone with the repository, wherein upon the aerial drone being docked with the repository, the article is deposited from the drone into the interior pace of the repository through a deposit hatch.

18. The method in accordance with claim 17, wherein the step of receiving the article further comprises scanning a Universal Product Code (UPC) tag attached to the article using a user interface associated with the deposit hatch.

19. The method in accordance with claim 16, wherein the user interface comprises an optical scanner, wherein the delivery notification comprises a Quick Response (QR) code, and wherein the step of receiving the instruction to provide the recipient with access comprises the user presenting the QR code to the user interface.

20. The method in accordance with claim 16, further comprising the step of transmitting a retrieval notification to a user computing device of the sender, wherein the retrieval notification provides an indication that the article was successfully retrieved from the repository.
